(19) United States
(12) Patent Application Publication
(10) Pub. No.: US 2012/0114347 A1
(43) Pub. Date: May 10, 2012

(54) IMAGE FORMING APPARATUS

(75) Inventors: Tomoaki SAKITA, Kanagawa (JP); Fumiya HISA, Kanagawa (JP); Toshiharu ORUI, Kanagawa (JP)

(73) Assignee: FUJI XEROX CO., LTD., Tokyo (JP)

(21) Appl. No.: 13/088,988

(22) Filed: Apr. 18, 2011

(30) Foreign Application Priority Data
Nov. 9, 2010 (JP) 2010-250782

(51) Int. Cl. G03G 15/00; G03G 15/043

(52) U.S. Cl. 399/51; 399/167

(57) ABSTRACT

An image forming apparatus includes a photosensitive member that rotates and is subjected to exposure so that a latent image is formed thereon, a driver that rotates the photosensitive member, an exposure section that exposes the photosensitive member by irradiating the photosensitive member with light, a light intensity adjustment section that receives a part of the light from the exposure section and adjusts intensity of the light irradiated by the exposure section, and an adjustment controller that causes the driver to start rotating the photosensitive member and causes the light intensity adjustment section to start adjusting the intensity of the light after a rotation speed of the photosensitive member exceeds a predetermined threshold value.

### CROSS-REFERENCE TO RELATED APPLICATION

This application is based on and claims priority under 35 USC 119 from Japanese Patent Application No. 2010-250782 filed on Nov. 9, 2010.

### BACKGROUND

### Technical Field

The present invention relates to an image forming apparatus.

### SUMMARY

According to an aspect of the invention, there is provided an image forming apparatus including:

a photosensitive member that rotates and is subjected to exposure so that a latent image is formed thereon;

a driver that rotates the photosensitive member;

an exposure section that exposes the photosensitive member by irradiating the photosensitive member with light;

a light intensity adjustment section that receives apart of the light from the exposure section and adjusts intensity of the light irradiated by the exposure section; and

an adjustment controller that causes the driver to start rotating the photosensitive member and causes the light intensity adjustment section to start adjusting the intensity of the light after a rotation speed of the photosensitive member exceeds a predetermined threshold value.

### BRIEF DESCRIPTION OF THE DRAWINGS

Exemplary embodiments of the present invention will be described in detail based on the following figures, wherein:

FIG. 1 is a schematic configuration diagram of an image forming apparatus according to an exemplary embodiment of the invention;

FIG. 2 is a perspective view of an exposure unit;

FIG. 3 is a planar view of an optical system disposed in a casing of the exposure unit;

FIG. 4 is a perspective view of the optical system disposed in the casing of the exposure unit;

FIG. 5 is a block diagram showing a configuration of a circuit for driving a photosensitive member and a laser diode;

FIG. 6 is a flowchart showing a control operation of a controller shown in FIG. 5; and

FIG. 7 is a timing chart showing changes in the signals output from the blocks shown in FIG. 4.

### DETAILED DESCRIPTION

Hereinafter, exemplary embodiments of the invention will be described with reference to the drawings.

Hereinafter, an exemplary embodiment of the invention will be described.

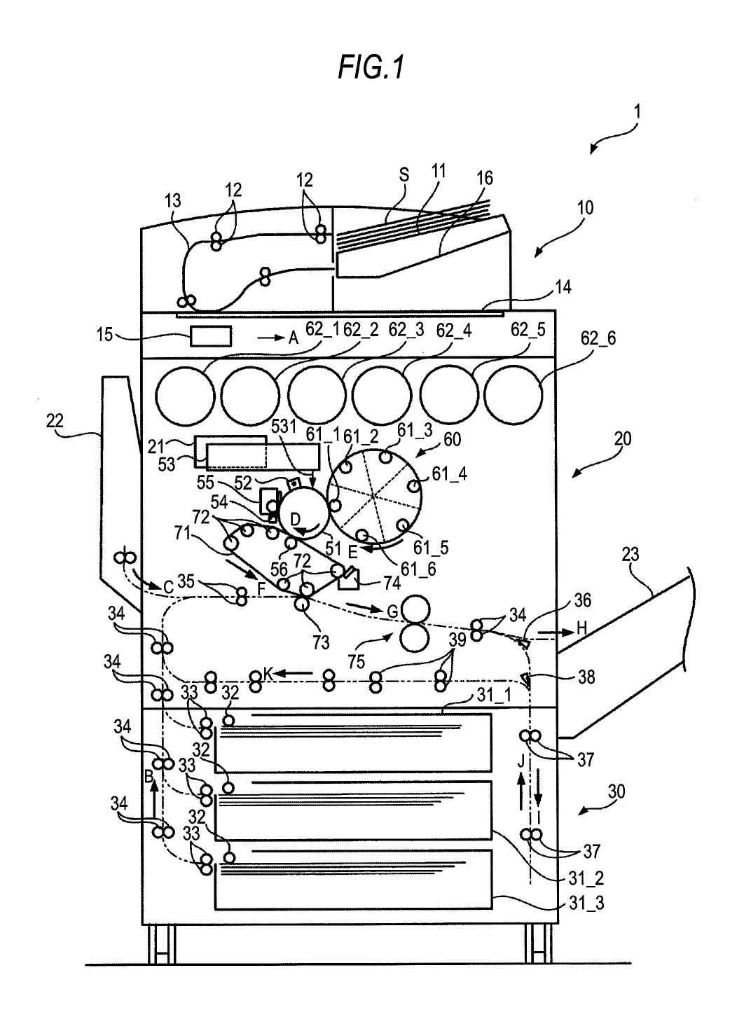

FIG. 1 is a schematic configuration diagram of an image forming apparatus according to an exemplary embodiment of the invention.

This image forming apparatus 1 includes a document reading section 10, an image forming section 20, and a sheet container 30.

The document reading section 10 is provided with a document feeding platen 11 on which documents S are placed in a stacked state. The documents S placed on the sheet feeding platen 11 are transported one by one along a transport path 13 by transport rollers 12. Characters and images recorded on the transported document are read by a document reading optical system 15 disposed under a document reading platen 14 made of a transparent glass, and the document is discharged onto a document discharge platen 16.

Moreover, the document reading section 10 includes a hinge which is disposed on the inner side so as to extend in the left-right direction, and the document feeding platen 11 and the document discharge platen 16 can be lifted together about the hinge. The document reading platen 14 appears wide under the lifted platens. In the document reading section 10, instead of placing documents on the document feeding platen 11, only one document with a recorded side facing downward may be placed on the document reading platen 14, and when the document reading optical system 15 moves in a direction indicated by an arrow A, characters and images may be read from the document on the document reading platen 14.

An image signal obtained by the document reading optical system 15 is input to a processing and control circuit 21. The processing and control circuit 21 forms an image based on the input image signal in the following manner. The processing and control circuit 21 also controls the operations of the respective sections of the image forming apparatus 1.

In the sheet container 30 provided in the lower part of the image forming apparatus 1, three feed cassettes 31_1, 31_2, and 31_3 are stored. In these feed cassettes 31_1, 31_2, and 31_3, sheets P of different sizes are stored in a stacked state in each of the respective feed cassettes 31_1, 31_2, and 31_3. The respective feed cassettes 31_1, 31_2, and 31_3 are configured to be freely drawn out to supply the sheets P.

From a feed cassette (in this example, the feed cassette 31_3) among these three feed cassettes 31_1, 31_2, and 31_3, in which sheets P of a size suitable for the size of a document are stored, the sheets P are delivered by a pickup roller 32 and separated one by one by separation rollers 33. The separated one sheet P is transported upward in a direction indicated by an arrow B by a transport roller 34 and is further transported by standby rollers 35 with a subsequent transport timing adjusted. The subsequent transport of a sheet having passed through the standby rollers 35 will be described later.

Moreover, the image forming section 20 includes a manual feed tray 22. The manual feed tray 22 is a folding type which is opened by being folded about the lower end thereof, and when the user opens the manual feed tray 22 and places a sheet thereon, the sheet placed on the manual feed tray 22 can be delivered in a direction indicated by an arrow C.

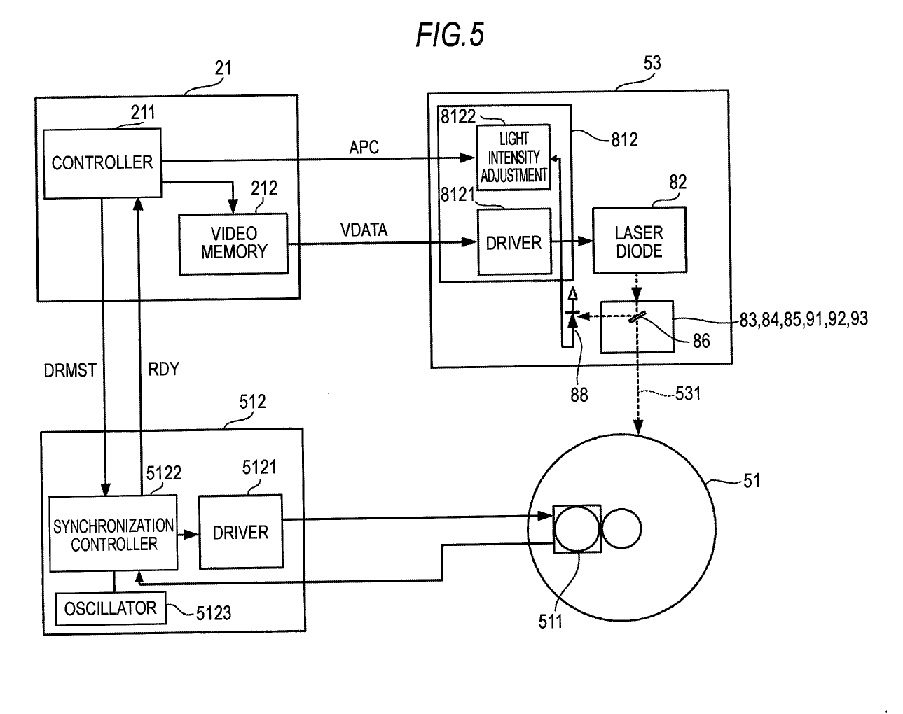

The image forming section 20 has a photosensitive member 51 which is disposed at the central portion thereof and which rotates in a direction indicated by an arrow D. Around the photosensitive member 51, a charger 52, a developing device 60, a neutralizer 54, and a cleaner 55 are arranged. Moreover, an exposure unit 53 is disposed above the photosensitive member 51. Furthermore, a transfer unit 56 is disposed at a position at which an intermediate transfer belt 71 described later is interposed between the transfer unit 56 and the photosensitive member 51. The photosensitive member 51 is driven by a motor 511 which is controlled by a photosensitive member driving circuit 512 shown in FIG. 5.

The photosensitive member 51 has a cylindrical shape and is configured to store charge through static electrification and discharge the charge through exposure, thus forming electrostatic latent images on the surface thereof.

The charger 52 charges the surface of the photosensitive member 51 to a certain charging potential.

The exposure unit 53 receives an image signal from a processing and control circuit 21 and outputs a light beam 531 which is modulated in accordance with the input image signal. This light beam 531 repeatedly scans a portion of the surface of the photosensitive member 51, which rotates in the direction indicated by the arrow D and which is charged by the charger 52, in a direction (a direction vertical to the drawing sheet of FIG. 1) of the rotating shaft of the photosensitive member 51, thus forming electrostatic latent images on the surface of the photosensitive member 51. After the electrostatic latent images are formed on the surface by being scanned by the light beam 531, the photosensitive member 51 is developed by the developing device 60, whereby toner images are formed on the surface of the photosensitive member 51. Here, the developing device 60 includes six developing units 61_1, 61_2, 61_3, 61_4, 61_5, and 61_6 and rotates in a direction indicated by an arrow E. Any one developing unit (in the example of FIG. 1, the developing unit 61_1) among these six developing units 61_1 to 61_6 is moved to a position where it faces the photosensitive member 51. The electrostatic latent images formed on the photosensitive member 51 are developed by a developing unit (in this example, the developing unit 61_1) facing the photosensitive member 51, whereby toner images are formed.

In the six developing units 61_1 to 61_6 provided in the developing device 60, toners of the six colors of yellow (Y), magenta (M), cyan (C), black (K), and two special colors corresponding to the purposes of the user are stored for each developing unit. Developing of the electrostatic latent images on the photosensitive member 51 is performed as follows. A developing unit storing toner of a presently used color is rotated to a position where it faces the photosensitive member 51, and the electrostatic latent images are developed by the developing unit facing the photosensitive member 51 using the color toner stored in the developing unit. As the special colors corresponding to the purposes of the user, a transparent toner which is used for giving a glazing effect to images, a toner adjusted to a color frequently used by the user, and the like are used, for example.

Above the developing device 60, six toner tanks 62_1 to 62_6 storing the same color toners as the color toners used by the six developing units 61_1 to 61_6 are disposed. When the amount of the toner stored in the respective developing units 61_1 to 61_6 decreases, toner is supplied from the toner tanks 62_1 to 62_6 storing the toner of the corresponding colors to the developing units 61_1 to 61_6.

The toner images formed on the photosensitive member 51 through the developing by the developing units are transferred onto the intermediate transfer belt 71 by the action of the transfer unit 56.

After the transfer, the photosensitive member 51 is subjected to neutralization treatment by the neutralizer 54, and toner remaining on the photosensitive member 51 after the transfer is removed by the cleaner 55.

The intermediate transfer belt 71 is an endless belt which is wound around plural rollers 72 and circulates in a direction indicated by an arrow F. A transfer unit 73 is disposed near the intermediate transfer belt 71 at a position where the transport path of the sheet P is interposed therebetween. Moreover, a cleaner 74 which removes toner remaining on the intermediate transfer belt 71 after the transfer by the transfer unit 73 is disposed closer to the downstream side of the circulating direction of the intermediate transfer belt 71 than the transfer unit 73. The transfer unit 73 and the cleaner 74 are configured to freely come into contact with and be separated from the intermediate transfer belt 71. When forming an image with plural colors, the transfer unit 73 and the cleaner 74 are separated from the intermediate transfer belt 71, and a process of forming a toner image on the photosensitive member 51 using toner of one color and transferring the toner image onto the intermediate transfer belt 71 is repeated for plural developing units (toner of plural colors) while rotating the developing device 60 so that plural toner images by toner of plural colors are sequentially transferred onto the intermediate transfer belt 71 so as to be superimposed onto each other.

Thereafter, the transfer unit 73 is brought into contact with the intermediate transfer belt 71, and the sheet P is delivered from the standby rollers 35 so that the sheet P arrives at the transfer position when the superimposed toner images of the plural colors arrive at the transfer position which the transfer unit 73 is positioned. At the transfer position, the toner images of the plural colors on the intermediate transfer belt 71 are transferred onto the sheet P by the action of the transfer unit 73. The sheet in which the toner images are transferred is further transported in a direction indicated by an arrow G, and is subjected to heating and pressurization by a fixing unit 75, whereby an image formed of the fixed toner images is formed on the sheet. The sheet having passed through the fixing unit 75 is further transported in a direction indicated by an arrow H and discharged onto a sheet discharge tray 23.

Moreover, the cleaner 74 is moved to come into contact with the intermediate transfer belt 71, and toner remaining on the intermediate transfer belt 71 after the transfer by the transfer unit 73 is removed from the intermediate transfer belt 71 by the cleaner 74.

Moreover, the image forming apparatus 1 is capable of forming images on both sides of the sheet P. When images are formed on both sides of the sheet P, the sheet P in which the image is formed on only a first side of the sheet P in the described manner is transported in a direction indicated by an arrow I by transport rollers 37 through the switching of a guide member 36 rather than being discharged onto the sheet discharge tray 23. After that, the transport direction is reversed, and the sheet P is transported by transport rollers 39 in a direction indicated by an arrow K through the switching of another guide member 38 and reaches the standby rollers 35.

Thereafter, by the processes described above, an image is formed on the second side of the sheet P. In this way, the sheet P in which images are formed on both sides thereof is discharged onto the sheet discharge tray 23.

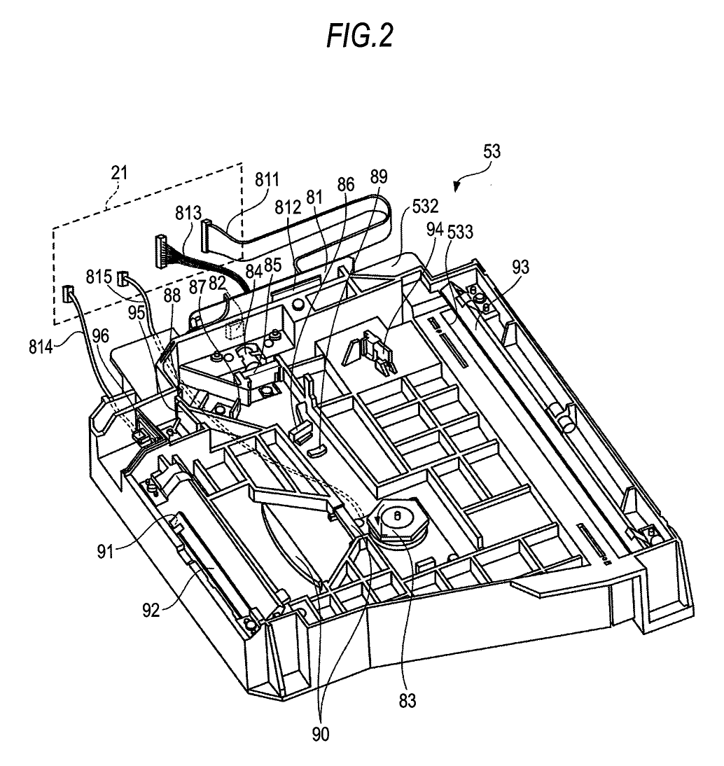

FIG. 2 is a perspective view of the exposure unit.

In FIG. 2, the cover of the exposure unit is removed, and the inner portion of the exposure unit is shown.

A circuit board 81 is fixed to a casing 532 of the exposure unit 53, and a field emission-type laser diode 82 is mounted on the circuit board 81. An image signal cable 811 and a power/adjustment control signal cable 813 are connected to the circuit board 81, and a driving circuit 812 is mounted on the circuit board 81. The laser diode 82 mounted on the circuit board 81 is a laser diode of a type that emits plural light beams. The exposure unit 53 is configured to simultaneously scan plural light beams on the photosensitive member 51 shown in FIG. 1.

The image signal cable 811 and the power/adjustment control signal cable 813 deliver an image signal and a power signal, and various control signals from the processing and control circuit 21 to the circuit board 81. The image signal delivered to the circuit board 81 through the image signal cable 811 is processed by the driving circuit 812 to be converted to a driving signal that controls the light beams emitted from the laser diode 82 for the purpose of exposure, and the processed signal is delivered to the laser diode 82. The laser diode 82 emits the plural light beams in accordance with the delivered driving signal. The power delivered through the power/adjustment control signal cable 813 is used for operating the circuit board 81 and driving the laser diode 82. The adjustment control signal delivered through the power/adjustment control signal cable 813 is used by the driving circuit 812 driving the laser diode 82 for the purpose of adjusting light intensity. Between the exposure unit 53 and the processing and control circuit 21, in addition to the image signal cable 811 and the power/adjustment control signal cable 813, a timing signal cable 814 that delivers a scanning start timing signal and a motor driving cable 815 that controls the motor of the exposure unit 53 are connected.

In the casing 532 of the exposure unit 53, a rotary polygon mirror 83 and plural optical members are disposed as an optical system.

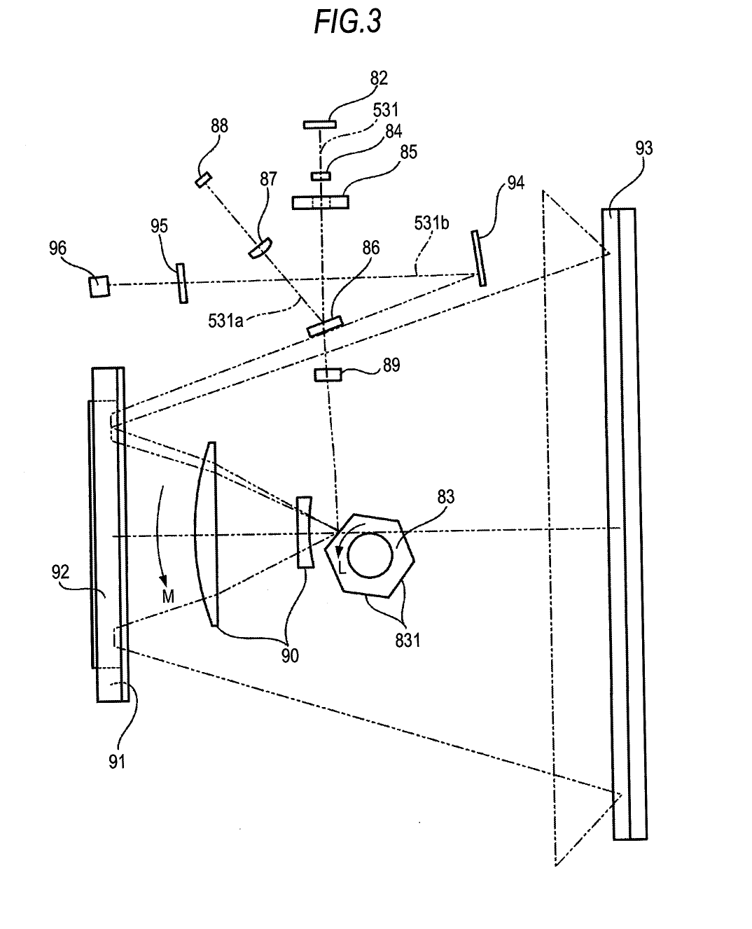

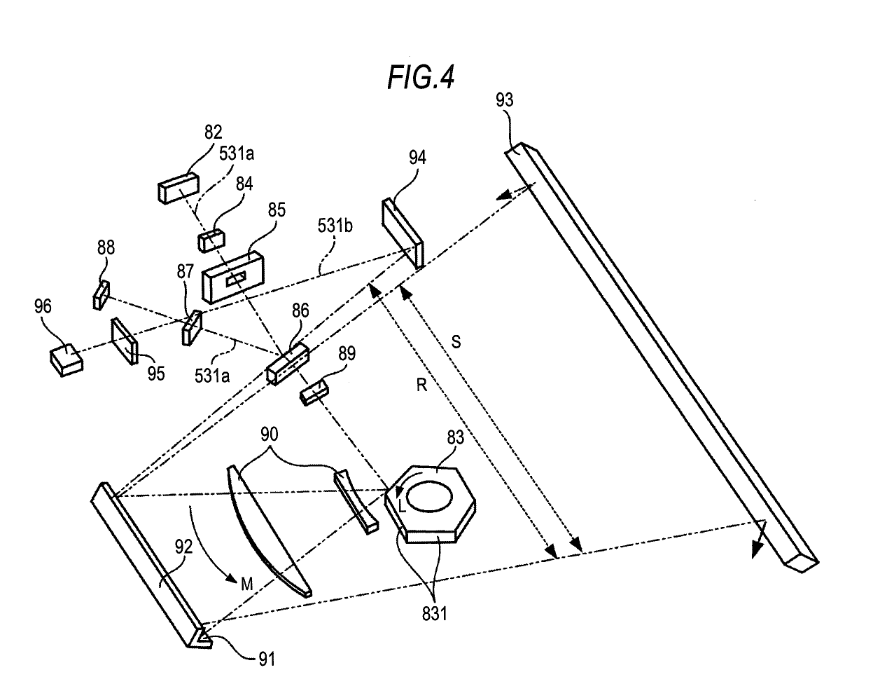

FIGS. 3 and 4 are a planar view and a perspective view of an optical system disposed in a casing of the exposure unit, respectively.

The plural light beams 531 emitted from the laser diode 82 arrive at a half mirror 86 after passing through a collimator lens 84 and an aperture 85. The half mirror 86 reflects part of the incident beams, and the reflected beams 531a are input to an optical sensor 88 for detecting light intensity through a focusing lens 87. A reception signal obtained by the optical sensor 88 is delivered to the circuit board 81 shown in FIG. 2, and the driving circuit 812 on the circuit board 81 adjusts the intensity of the light beams emitted from the laser diode 82 based on the reception signal.

The light beams having passed through the half mirror 86 arrive at the rotary polygon mirror 83 through a cylindrical lens 89. The rotary polygon mirror 83 has a peripheral surface 831 which is configured as a reflecting mirror and thus reflects an incident beam in a direction corresponding to a rotation angle thereof. The rotary polygon mirror 83 rotates in a direction indicated by an arrow L, and accordingly, the reflected beams are repeatedly deflected in a direction indicated by an arrow M.

The light beams reflected from the rotary polygon mirror 83 pass through an fθ lens 90 and are reflected upward from a cylindrical mirror 91 and reflected from a planar mirror 92 in a direction of folding the optical path. The light beams reflected from the mirror 92 pass through the fθ lens 90 and the upper part of the rotary polygon mirror 83 and are reflected downward from a cylindrical mirror 93 and emitted to the lower side of the casing 532 through an opening 533 (see FIG. 2) formed in the casing 532. The light beams 531 emitted from the casing 532 of the exposure unit 53 scan the photosensitive member 51 in the direction of the rotation shaft thereof as shown in FIG. 1, whereby electrostatic latent images are formed on the photosensitive member 51.

Moreover, as shown in FIG. 4, a reflecting mirror 94 is disposed at a position which is within a deflection range R of the light beams by the rotary polygon mirror 83 and which is outside a scanning region S used for scanning the photosensitive member 51. The light beams reflected from the mirror 92 are reflected from the reflecting mirror 94 at the start timing of one scanning operation. The light beams 531b reflected from the reflecting mirror 94 are incident on a timing detection optical sensor 96 through a focusing lens 95.

The timing detection optical sensor 96 is a sensor that detects the start timings of the respective scanning operations in order to adjust the timings for modulating light beams. The reception signal obtained by the timing detection optical sensor 96 is delivered to the processing and control circuit 21 shown in FIG. 1, and the processing and control circuit 21 generates an image signal of which the timing is adjusted based on the reception signal and delivers the adjusted image signal to the circuit board 81. In this way, the light beams 531 of which the intensity is adjusted based on the reception signal of the optical sensor 88 and which are modulated in accordance with the modulation signal of which the timing is adjusted based on the reception signal of the timing detection optical sensor 96 are emitted from the laser diode 82.

FIG. 5 is a block diagram showing a configuration of a circuit for driving a photosensitive member and a laser diode.

The driving circuit 812 of the exposure unit 53 includes a driver 8121 that drives the laser diode 82 and a light intensity adjustment section 8122 that adjusts the light intensity of the laser diode 82. The driver 8121 drives the laser diode 82 based on the image signal VDATA supplied from the processing and control circuit 21 and causes the laser diode 82 to emit light beams. The light beams 531 emitted from the laser diode 82 are irradiated onto the photosensitive member 51 through the optical system including the rotary polygon mirror 83 and other optical members (83, 84, 85, 91, 92, and 93) described with reference to FIGS. 3 and 4.

The light intensity adjustment section 8122 receives a light intensity adjustment signal APC from the processing and control circuit 21 and adjusts the intensity of light emitted from the laser diode 82. The optical sensor 88 receives part of the light beams 531 reflected from the half mirror 86. The light intensity adjustment section 8122 adjusts a current used by the driving circuit 812 driving the laser diode 82 based on the level of a signal, which is output by the optical sensor 88 in accordance with the incident light intensity, and a predetermined reference level.

The motor 511 that rotates the photosensitive member 51 is driven by the photosensitive member driving circuit 512. Upon receiving a drum start signal DRMST from the processing and control circuit 21, the photosensitive member driving circuit 512 supplies power to the motor 511 so as to rotate the motor 511 at a rotation speed within a predetermined target range. The photosensitive member driving circuit 512 includes a driver 5121 that generates a driving voltage waveform to supply it to the motor 511, a synchronization controller 5122 that controls the waveform output by the driver 5121, and an oscillator 5123. The driver 5121 receives a pulse signal indicating a rotation speed output from the motor 511 and a clock signal indicating a target speed from the oscillator 5123 and controls an output timing of the waveform output by the driver 5121 so that the pulse signal from the motor 511 is synchronized to the clock signal. The clock signal may be supplied from the processing and control circuit 21.

The synchronization controller 5122 controls the rotation speed of the photosensitive member 51 through PLL (Phase Lock Loop) control so as to be maintained in a normal state which is within a predetermined allowable range of the target speed. The motor 511 has a sensor (not shown) formed, for example, of the Hall element and outputs a pulse signal corresponding to rotation. The synchronization controller 5122 controls the timing of a voltage waveform output by the driver 5121 so that the pulse signal from the motor 511 is synchronized to the phase of the clock signal. The rotation speed at which the motor 511 rotates the photosensitive member 51 is referred to simply as the speed of the motor 511. Since the pulse signal is not output from the motor 511 immediately after the motor 511 starts, and even if the pulse signal is output, the cycle of the pulse signal is not synchronized to the cycle of the clock signal, the PLL control is not executed. When the drum start signal DRMST is received in the stopped state of the motor 511, first, the synchronization controller 5122 outputs a voltage waveform that is not synchronized to the clock signal to the driver 5121 so as to rotate the motor 511. When the motor 511 starts rotating, and the rotation speed increases to be within an allowable range where the PLL control is possible, the synchronization controller 5122 starts PLL control (PLL lock) so as to perform normal state control so that the pulse signal from the motor 511 is synchronized to the phase of the clock signal. When the synchronization controller 5122 maintains the rotation speed of the photosensitive member 51 in the normal state, latent images having substantially no deformation are formed on the photosensitive member 51. The allowable range of the normal state is set to a range of 10% (±5%) of the target speed, for example. When the rotation speed of the motor 511 exceeds the lower limit (for example, 95% of the target speed) within the allowable range of the normal state, the synchronization controller 5122 outputs a normal state signal RDY indicating that the normal state is realized.

The processing and control circuit 21 controls the driving circuit 812 of the laser diode 82 and the photosensitive member driving circuit 512 to cause the photosensitive member driving circuit 512 to start rotating the photosensitive member 51. When the rotation speed of the photosensitive member 51 exceeds a threshold value, the processing and control circuit 21 causes the driving circuit 812 to start adjusting the light intensity. The processing and control circuit 21 includes a controller 211 and a video memory 212. The controller 211 includes a processor (not shown) that executes programs and a program memory, and controls the respective sections of the image forming apparatus 1 including the photosensitive member driving circuit 512 and the driving circuit 812. The video memory 212 is a FIFO (First-In First-Out) memory and stores data for causing the laser diode 82 to emit light beams based on the data of images formed by the exposure unit 53. The data are read from the video memory 212 under the control of the controller 211 and output as an image signal.

Here, the photosensitive member driving circuit 512 and the motor 511 correspond to an example of the driver according to an exemplary embodiment of the invention, and the light intensity adjustment section 8122 corresponds to the light intensity adjustment section according to an exemplary embodiment of the invention. Moreover, the controller 211 corresponds to an example of the adjustment controller according to an exemplary embodiment of the invention.

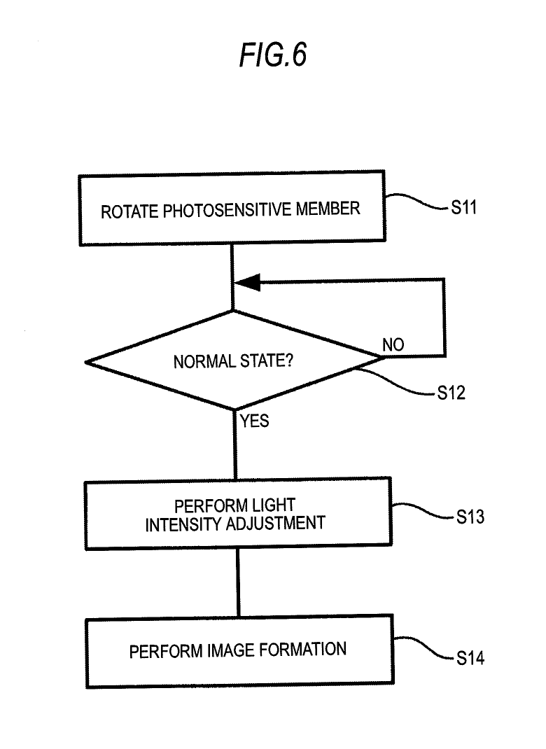

FIG. 6 is a flowchart showing a control operation of the controller shown in FIG. 5. In the flowchart of FIG. 6, the process of driving the laser diode 82 and the process relating to the photosensitive member 51 are shown.

Although the processes shown in FIG. 6 are executed after power is supplied to the image forming apparatus 1 and image data are input in the standby state and before printing is started, the processes may be executed in other periods as necessary.

In the process shown in FIG. 6, first, the controller 211 starts rotating the photosensitive member 51 (S11). Specifically, the controller 211 sends a drum start signal DRMST to the photosensitive member driving circuit 512. Upon receiving the drum start signal DRMST, the synchronization controller 5122 and the driver 5121 of the photosensitive member driving circuit 512 supplies a voltage waveform to the motor 511 to cause the motor 511 to start rotating the photosensitive member. In this case, there is a small delay between the supply of a voltage waveform to the motor 511 and the time when the photosensitive member 51 actually starts rotating.

Subsequently, the controller 211 determines whether or not the photosensitive member 51 is in a normal rotation state (S12). Specifically, the controller 211 determines whether or not the synchronization controller 5122 has output a normal state signal RDY. The controller 211 repeats the determination process of step S12 until the normal state signal RDY is output. When the rotation speed of the motor 511 increases to exceed the lower limit of the allowable range of the normal state, and the normal state signal RDY is output (S12: Yes), the controller 211 performs light intensity control (S13). The controller 211 sends a light intensity adjustment signal APC to the light intensity adjustment section 8122. Upon receiving the light intensity adjustment signal APC, the light intensity adjustment section 8122 causes the driver 8121 to drive the laser diode 82. Parts of the light beams emitted from the laser diode 82 are incident on the optical sensor 88, and the remaining light beams are irradiated onto the photosensitive member 51. The light intensity adjustment section 8122 adjusts the current used by the driving circuit 812 driving the laser diode 82 based on the level of the signal output by the optical sensor 88 and a reference level. Through the determination process of step S12, the controller 211 causes the laser diode to emit the light beams only when the rotation speed of the motor 511 exceeds the lower limit of the allowable range of the normal state.

Subsequently, the controller 211 performs image formation (S14). The controller 211 reads the data stored in the video memory 212 and outputs the data as an image signal VDATA. The driver 8121 causes the laser diode 82 to emit light beams with the light intensity adjusted by the light intensity control (S13) based on the image signal VDATA. The light beams 531 are irradiated onto the photosensitive member 51 through the optical system including the rotary polygon mirror 83 and other optical members (83, 84, 85, 91, 92, and 93). In this way, latent images are formed on the photosensitive member 51.

The controller 211 performs the light intensity control (S13) and the image formation (S14) after determining in step S12 whether or not the rotation of the photosensitive member 51 is in the normal state. Therefore, emission of light beams is inhibited until the rotation speed of the photosensitive member 51 falls within the allowable range of the normal state, and the light beams are emitted only when the rotation speed is in the allowable range of the normal state.

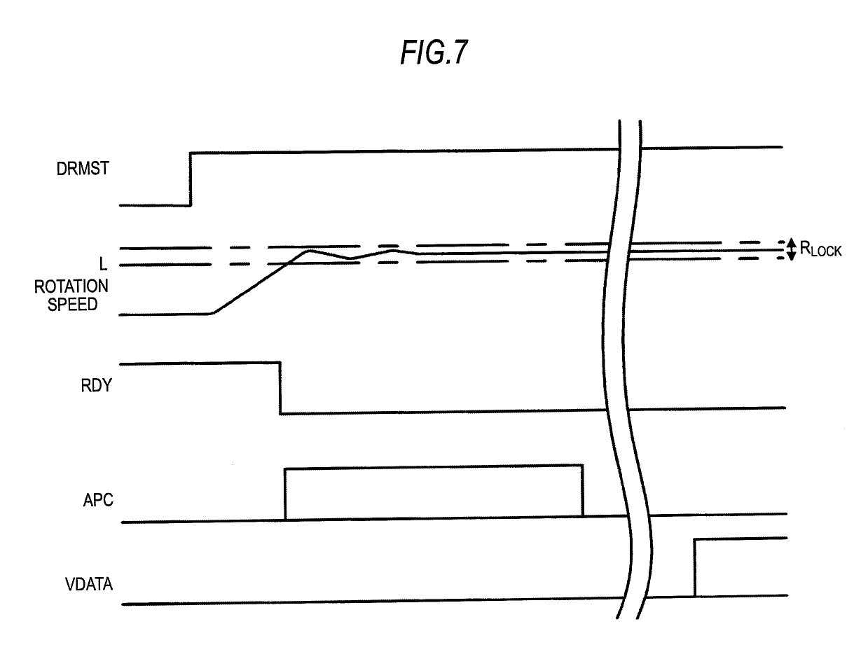

FIG. 7 is a timing chart showing changes in the signals output from the blocks shown in FIG. 4. In the timing chart shown in FIG. 7, signals relating to the rotation of the photosensitive member 51 and the light intensity adjustment shown in FIG. 5 are shown.

When the drum start signal DRMST is output from the controller 211, the photosensitive member 51 is rotated, and the rotation speed increases. In this case, there is a small delay between the reception of the driving voltage waveform and the start of the rotation. That is, there is a small time difference between the time when the drum start signal DRMST is output and the time when the motor 511 starts rotating the photosensitive member 51. After the motor 511 starts rotating, when the rotation speed increases to exceed the lower limit L of the allowable range RLOCK of the normal state, the synchronization controller 5122 outputs the normal state signal RDY indicating that the normal state is realized.

When the normal state signal RDY is output, the controller 211 sends the light intensity adjustment signal APC to the light intensity adjustment section 8122, and the laser diode 82 emits light beams, whereby adjustment of light intensity is realized. After the adjustment of light intensity is realized, the image signal VDATA is output from the video memory 212. The photosensitive member 51 is exposed by light beams corresponding to the image signal VDATA, and latent images are formed thereon.

The time difference (delay) between the time when the drum start signal DRMST is output and the time when the motor 511 starts rotating the photosensitive member 51 is longer than the period elapsed until the light beams are emitted after the controller 211 sends the light intensity adjustment signal APC immediately after sending the drum start signal DRMST, for example. This time difference may further increase depending on the lubrication state and the wearing of the motor 511 and the photosensitive member 51 and other conditions such as intervening foreign matter.

If light beams are emitted for light intensity adjustment from the laser diode 82 before the photosensitive member 51 starts rotating, the light beams may concentrate on a particular region on the stopped photosensitive member 51. That is, even when the light beams are scanned on the rotary polygon mirror 83 that is rotating, the light beams are intensively irradiated on one straight line on the photosensitive member 51. The region in which the light beams are intensively irradiated receives extremely strong energy as compared to the time of forming general latent images, and deterioration thereof progresses.

In the image forming apparatus 1 of the present exemplary embodiment, the controller 211 outputs the drum start signal DRMST to cause the photosensitive member driving circuit 512 to start rotating the photosensitive member 51 and causes the light intensity adjustment section 8122 to start adjusting light intensity when the rotation speed at which the motor 511 rotates the photosensitive member 51 exceeds the predetermined threshold value L. Moreover, the formation of latent images in accordance with the image signal is also executed when the light intensity is adjusted, namely at least when the rotation speed of the photosensitive member 51 exceeds the predetermined threshold value L. Therefore, the light beams are irradiated on the photosensitive member 51 which is securely rotating. Therefore, since the light beams are prevented from being intensively irradiated on a particular region of the photosensitive member 51, the deterioration of the photosensitive member 51 is suppressed and the replacement cycle of the photosensitive member 51 is extended as compared to when the light beams are intensively irradiated on the particular region.

In the image forming apparatus 1 of the present exemplary embodiment, in order to maintain the rotation speed of the photosensitive member 51, the synchronization controller 5122 of the photosensitive member driving circuit 512 controls the rotation speed to be maintained in a normal state within the allowable range RLOCK. The lower limit L of the allowable range RLOCK is used as the threshold value of the rotation speed at which the light intensity adjustment section 8122 starts the light intensity adjustment operation. Thus, the normal state signal RDY which is used for expressing the normal state during general image formation is used as it is. Therefore, it is possible to simplify the configuration as compared to when a special component for determining the rotation speed is provided.

In the exemplary embodiment described above, although the image forming apparatus 1 having six developing units 61_1 to 61_6 and one photosensitive member 51 has been illustrated as an example of the image forming apparatus of the invention, the image forming apparatus of the invention is not limited to this, and may be a so-called tandem-type apparatus and may be a monochrome-only apparatus.

Moreover, in the exemplary embodiment described above, although the image forming apparatus 1 having the document reading section 10 has been illustrated as an example of the image forming apparatus of the invention, the image forming apparatus of the invention may be a printer and a facsimile, for example.

The foregoing description of the exemplary embodiments of the invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best exemplify the principles of the invention and its practical applications, thereby enabling others skilled in the art to understand the invention for various embodiments and with the various modifications as are suited to the particular use contemplated. It is intended that the scope of the invention is defined by the following claims and their equivalents.

What is claimed is:

1. An image forming apparatus comprising:
a photosensitive member that rotates and is subjected to exposure so that a latent image is formed thereon;
a driver that rotates the photosensitive member;
an exposure section that exposes the photosensitive member by irradiating the photosensitive member with light;
a light intensity adjustment section that receives apart of the light from the exposure section and adjusts intensity of the light irradiated by the exposure section; and
an adjustment controller that causes the driver to start rotating the photosensitive member and causes the light intensity adjustment section to start adjusting the intensity of the light after a rotation speed of the photosensitive member exceeds a predetermined threshold value.

2. The image forming apparatus according to claim 1,
wherein the driver controls the rotation speed of the photosensitive member so that the rotation speed of the photosensitive member is maintained in a normal state, the normal state being configured to be a state that the rotation speed of the photosensitive member is within an allowable range of a target speed, and
wherein the light intensity adjustment section uses a lower limit of the allowable range as the predetermined threshold value.
